(19) United States
(12) Patent Application Publication
(10) Pub. No.: US 2024/0188186 A1
(43) Pub. Date: Jun. 6, 2024

(54) METHOD AND APPARATUS FOR DRX OPERATION FOR MULTICAST AND BROADCAST SERVICES

(71) Applicant: LENOVO (BEIJING) LIMITED, Beijing (CN)

(72) Inventors: Mingzeng Dai, Shanghai (CN); Jing Han, Beijing (CN); Congchi Zhang, Shanghai (CN); Haipeng Lei, Beijing (CN); Lianhai Wu, Beijing (CN)

(21) Appl. No.: 18/553,622

(22) PCT Filed: Apr. 1, 2021
(86) PCT No.: PCT/CN2021/085045

§ 371 Date: Oct. 2, 2023

(51) Int. Cl. H04W 76/40; H04L 1/1829; H04W 76/28

(52) U.S. Cl. CPC H04W 76/40; H04L 1/1848; H04W 76/28

(57) ABSTRACT

Embodiments of the present application are directed to a method and apparatus for DRX operation for MBS. A method performed by a UE. The UE is configured with an MBS DRX operation. The method may include: during an active time period for the MBS DRX operation, monitoring a point to multipoint (PTM) initial transmission associated with a MBS from a base station, wherein the PTM initial transmission is further associated with a first identifier; and monitoring a PTM retransmission associated with the MBS from a base station, wherein the PTM retransmission is further associated with the first identifier, or a second identifier, or both of the first and second identifiers.

### TECHNICAL FIELD

Embodiments of the present application generally relate to wireless communication technology, especially to a method and apparatus for discontinuous reception (DRX) operation for multicast and broadcast services (MBS).

### BACKGROUND

In new radio (NR) Rel-17, the MBS plans to focus on a small area mixed mode multicast (also referred to as Objective A in the TR 23.757). The Objective A is about enabling general MBS services over 5G system (5GS) and the identified use cases that could benefit from this feature. These use cases include but are not limited to: public safety and mission critical, vehicle to everything (V2X) applications, transparent internet protocol version 4 (IPv4)/internet protocol version 6 (IPv6) multicast delivery, internet protocol television (IPTV), software delivery over wireless, group communications and internet of things (IoT) applications. The NR MBS will support the multicast service of a user equipment (UE) in RRC_CONNECTED state.

In NR MBS, there are two modes for data transmission: point to multipoint (PTM) transmission and point to point (PTP) transmission. For high reliability multicast service, hybrid automatic repeat request (HARQ) and retransmission will be supported for NR MBS. An initial transmission may be provided in a PTM way, while the HARQ retransmission may be provided in a PTP way.

Therefore, how to realize efficient power saving for NR MBS for a UE in high reliability multicast service supporting HARQ and retransmission needs to be considered.

### SUMMARY OF THE APPLICATION

Embodiments of the present application provide a method and apparatus for DRX operation for MBS.

Some embodiments of the present application provide a method performed by a user equipment (UE). The UE is configured with an MBS DRX operation. The method may include: during an active time period for the MBS DRX operation, monitoring a point to multipoint (PTM) initial transmission associated with a MBS from a base station, wherein the PTM initial transmission is further associated with a first identifier; and monitoring a PTM retransmission associated with the MBS from a base station, wherein the PTM retransmission is further associated with the first identifier, or a second identifier, or both of the first and second identifiers.

Some other embodiments of the present application provide a method, performed by a BS. The method may include: configuring a value for at least one timer for a point to multipoint (PTM) initial transmission, PTM retransmission, and a point to point (PTP) transmission of multicast and broadcast services (MBS) discontinuous reception (DRX) operation to a UE.

Some other embodiments of the present application provide an apparatus. The apparatus may include a processor; and a wireless transceiver coupled to the processor. The processor is configured to perform the above method with the wireless transceiver.

Embodiments of the present application can realize efficient power saving for NR MBS for a UE in high reliability multicast service supporting HARQ and retransmission.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system 100 according to some embodiments of the present application;

FIG. 2 is a flow chart illustrating a method for DRX operation for MBS according to some embodiments of the present application;

FIG. 3 is a schematic diagram illustrating a configuration for an MBS specific DRX operation and a unicast DRX operation according to some embodiments of the present application;

FIG. 4 is a diagram illustrating a method for configuring DRX operation for MBS according to an embodiment of the present application;

FIG. 5 is a diagram illustrating a method for configuring DRX operation for MBS according to another embodiment of the present application;

FIG. 6 is a diagram illustrating a method for configuring DRX operation for MBS according to another embodiment of the present application;

FIG. 7 illustrates an apparatus according to some embodiments of the present application; and

FIG. 8 illustrates another apparatus according to some other embodiments of the present application.

### DETAILED DESCRIPTION

The detailed description of the appended drawings is intended as a description of the currently preferred embodiments of the present application and is not intended to represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. Persons skilled in the art know very well that, with the development of network architecture and new service scenarios, the embodiments in the present application are also applicable to similar technical problems.

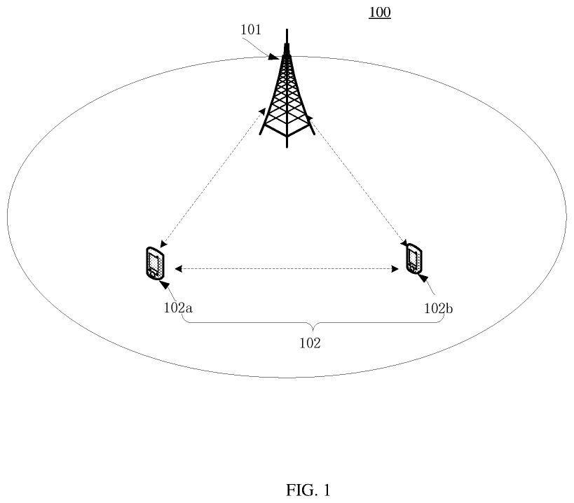

FIG. 1 is a schematic diagram illustrating an exemplary wireless communication system 100 according to an embodiment of the present application.

As shown in FIG. 1, a wireless communication system 100 includes at least one BS 101 and at least one UE 102. In particular, the wireless communication system 100 includes one BS 101 and two UEs 102 (e.g., UE 102a and UE 102b) for illustrative purpose. Although a specific number of BS 101 and UEs 102 are depicted in FIG. 1, it is contemplated that any number of BSs 101 and UEs 102 may be included in the wireless communication system 100.

The BS 101 may also be referred to as an access point, an access terminal, a base, a macro cell, a node-B, an enhanced node B (eNB), a gNB, a home node-B, a relay node, or a device, or described using other terminology used in the art. The BS 101 is generally part of a radio access network that may include a controller communicably coupled to the BS 101.

The UE(s) 102 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to an embodiment of the present application, the UE 102(s) may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments, the UE 102(s) may include wearable devices, such as smart watches, fitness bands, optical head-mounted displays, or the like. Moreover, the UE 102(s) may be referred to as a subscriber unit, a mobile, a mobile station, a user, a terminal, a mobile terminal, a wireless terminal, a fixed terminal, a subscriber station, a user terminal, or a device, or described using other terminology used in the art.

The wireless communication system 100 is compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In NR MBS, there are two modes for data transmission: PTM transmission and PTP transmission.

In PTM transmission, a BS may deliver a single copy of MBS data packets to a set of UEs. That is, the BS uses group-common physical downlink control channel (PDCCH) with CRC scrambled by group-common radio network temporary identifier (RNTI) (e.g. group RNTI (G-RNTI)) to schedule group-common physical downlink share channel (PDSCH) which is scrambled with the same group-common RNTI.

In PTP transmission, a BS may individually deliver separate copies of MBS data packets to UEs. That is, the BS uses UE-specific PDCCH with cyclic redundancy check (CRC) scrambled by UE-specific RNTI (e.g., cell radio network temporary identifier (C-RNTI)) to schedule UE-specific PDSCH which is scrambled with the same UE-specific RNTI.

For example, as shown in FIG. 1, the BS 101 may transmit a single copy of MBS data packets to the UE 102a and UE 102b via PTM transmission. In another example, the BS 101 may transmit separate copies of MBS data packets to the UE 102a and UE 102b via PTP transmission.

As discussed above, for high reliability multicast service, HARQ and retransmission will be supported for NR MBS. The initial transmission may be provided in a PTM way, while the HARQ retransmission may be provided in a PTP way.

DRX is a key feature for power saving in a UE. It allows the UE to stop monitoring PDCCH during periods of time when there is no data activity, thereby saving power. In LTE, there is one DRX operation for unicast traffic (or unicast transmission) and one DRX operation for each G-RNTI/single cell-multicast traffic channel (SC-MTCH) for single cell-point to multipoint (SC-PTM). There is a difference in the DRX operation for the unicast transmission and the DRX operation for SC-PTM in that the latter applies both for RRC_IDLE and RRC_CONNECTED and the latter lacks DRX short cycle functionality and functionality related to HARQ timers and retransmission timers. The existing HARQ and retransmission related timers include: drx-HARQ-RTT-TimerDL and drx-RetransmissionTimerDL. Each of the two timers is per downlink (DL) HARQ process except for the broadcast process. drx-HARQ-RTT-TimerDL may be used to indicate the minimum duration before a DL assignment for HARQ retransmission. drx-RetransmissionTimerDL may be used to indicate the maximum duration until a DL retransmission is received.

Generally, RRC controls DRX operation by configuring the following parameters:
drx-onDurationTimer: the duration at the beginning of a DRX Cycle;
drx-SlotOffset: the delay before starting the drx-onDurationTimer;
drx-InactivityTimer: the duration after the PDCCH occasion in which a PDCCH indicates a new UL or DL transmission for the MAC entity;
drx-RetransmissionTimerDL (per DL HARQ process except for the broadcast process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX Cycle starts;
drx-ShortCycle (optional): the Short DRX cycle;
drx-ShortCycle Timer (optional): the duration the UE follows the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity.

It should be understood by persons skilled in the art that the above parameters are just some existing parameters for DRX operation, and illustrating them is just used to facilitate the reader's understanding of the existing DRX operation, which cannot be used to limit the present application.

NR MBS will have some support for HARQ, so it is not possible to copy the LTE SC-PTM solution. Therefore, the following issues would be considered:
(1) The first question for DRX support for NR MBS should be if the existing DRX operation is sufficient or if it needs to introduce a separate DRX operation for MBS for monitoring of the G-RNTI(s); and
(2) In NR MBS, the initial transmission is scheduled by common PDCCH scrambled by G-RNTI in a PTM way, while the retransmission may be scheduled by a specific PDCCH scramble by C-RNTI in a PTP way. Thus, how to implement retransmission related DRX timers would be addressed.

By taking the above issues into consideration, the following embodiments of the present application can realize efficient power saving for NR MBS for a UE in high reliability multicast service supporting HARQ and retransmission. More details on embodiments of the present application will be illustrated in the following text in combination with the appended drawings.

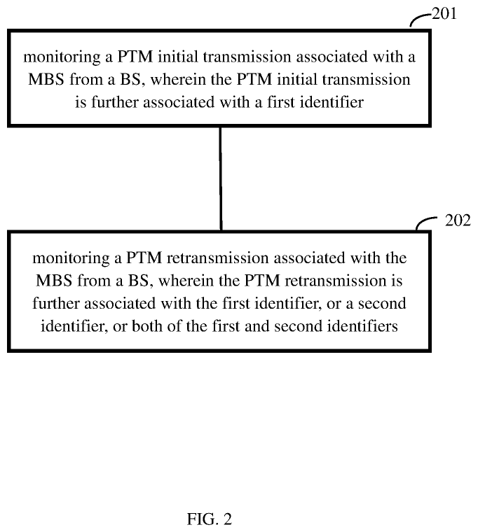

FIG. 2 is a flow chart illustrating a method for DRX operation for MBS according to some embodiments of the present application. The method illustrated in FIG. 2 may be implemented by a UE (e.g., UE 102a or UE 102b as shown in FIG. 1). The UE may be configured with an MBS DRX operation (or called MBS specific DRX operation).

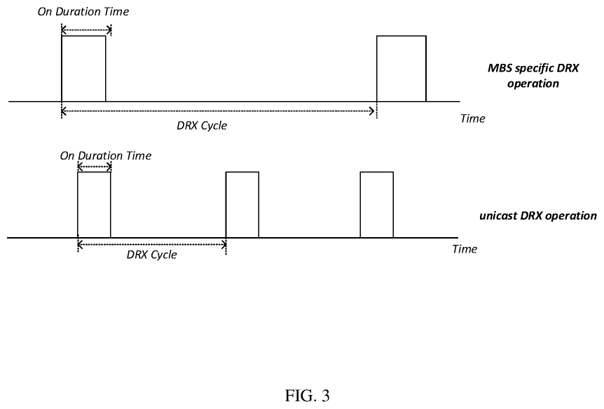

FIG. 3 is a schematic diagram illustrating an MBS specific DRX operation and a unicast DRX operation (or called a DRX operation for unicast, which is a legacy DRX operation). As shown in FIG. 3, the DRX cycle for the MBS specific DRX operation may be different from (such as, longer than) that of the unicast DRX operation, and the on-duration time for the MBS specific DRX operation may be also different than (such as, longer than) that of the unicast DRX operation. It should be understood that it is just an example, and in some examples, the DRX cycle for the MBS specific DRX operation may be shorter than that of the unicast DRX operation, so is the on-duration time.

In the embodiments of the present application, a PTM transmission and a PTP transmission may be used for MBS. The PTM transmission can include a PTM initial transmission and a PTM retransmission. The PTM retransmission may include a PTM retransmission over PTP and a PTM retransmission over PTM.

In a PTM initial transmission, a BS delivers a single copy of MBS data packets to a set of UEs. That is, the BS uses group-common PDCCH with CRC scrambled by group-common RNTI to schedule group-common PDSCH which is scrambled with the same group-common RNTI.

In a PTM retransmission over PTP, a HARQ retransmission in a manner of a PTP transmission to a specific UE for PTM initial transmission is performed.

In a PTM retransmission over PTM, a HARQ retransmission in manner of a PTM transmission to a group of UEs is performed.

In a PTP transmission, a BS may individually deliver separate copies of MBS data packets to UEs. That is, the BS uses UE-specific PDCCH with CRC scrambled by UE-specific RNTI (e.g., C-RNTI) to schedule UE-specific PDSCH which is scrambled with the same UE-specific RNTI.

During the MBS, transmission for a multicast radio bearer (MRB) can be performed. For example, a common PDCP layer in the BS may be used for the MRB so that the BS may deliver a single copy of MBS data packets to a set of UEs in PTM transmission, and the BS may individually deliver separate copies of MBS data packets to UEs in PTP transmission. Contrary to the MBS, a unicast data radio bearer (DRB) is for a unicast transmission.

In some embodiments of the present application, during an active timer period, the UE may perform the operations as shown in FIG. 2.

Before the operations as shown in FIG. 2, the BS may configure a value for at least one timer for PTM initial transmission, PTM retransmission, and PTP transmission of MBS DRX operation or at least one timer for unicast transmission to a UE.

The timer for MBS DRX operation may include one or more of an MBS DRX on duration timer, an MBS DRX inactivity timer, an MBS DRX retransmission timer, and an MBS DRX HARQ RTT timer, which will be described in detail in connection with the following specific embodiments.

As shown in FIG. 2, in operation 201, the UE may monitor a PTM initial transmission associated with a MBS from the BS, the PTM initial transmission is further associated with a first identifier. In operation 202, the UE may monitor a PTM retransmission associated with the MBS from the BS, the PTM retransmission is further associated with the first identifier, or a second identifier, or both of the first and second identifiers. For example, the first identifier is a G-RNTI, and the second identifier is a C-RNTI of the UE. The first and second identifiers can be other preserved identifiers in the NR network or LTE network. The following description will describe the operations 201 and 202 in conjunction with some specific embodiments.

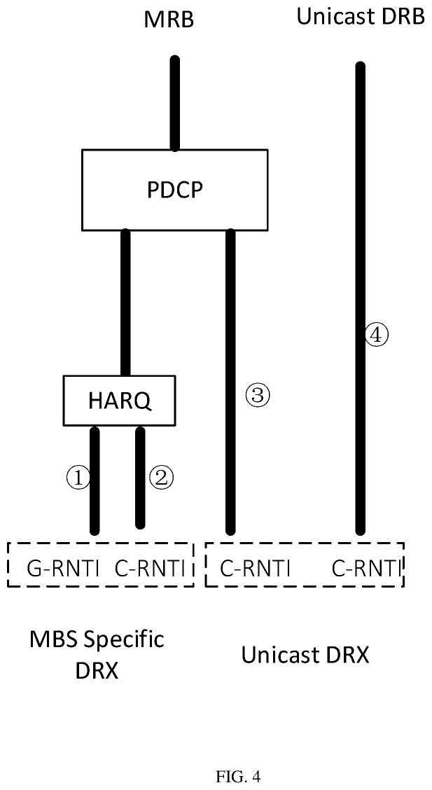

FIG. 4 is a diagram illustrating a method for configuring DRX operation for MBS according to an embodiment of the present application.

As shown in FIG. 4, \textcircled{1} may represent a PTM transmission including a PTM initial transmission and/or a PTM retransmission over PTM, \textcircled{2} may represent a PTM retransmission over PTP, \textcircled{3} may represent a PTP transmission, and \textcircled{4} may represent a unicast transmission.

In this embodiment, the MBS specific DRX operation is configured for PTM initial transmission (\textcircled{1}), PTM retransmission over PTP(\textcircled{2}), and PTM retransmission over PTM (\textcircled{1}), while a unicast DRX operation is used for PTP transmission (\textcircled{3}) (that is, both initial transmission and retransmission over PTP transmission) and a unicast transmission (\textcircled{4}).

In this embodiment, the MBS specific DRX operation may be per G-RNTI or per MBS session. And the HARQ retransmission related timers (for example, MBS DRX retransmission timer and MBS DRX HARQ RTT timer) are also MBS specific. For example, the HARQ retransmission related timers can be per MBS specific DRX operation (that is, per G-RNTI).

In particular, if MBS specific DRX operation is configured for a G-RNTI, the UE is allowed to monitor the PDCCH for this G-RNTI discontinuously using the DRX operation specified. RRC controls its DRX operation by configuring the timers:
MBS DRX on duration timer (may be represented as drx-onDurationTimerMBS), which indicates the duration at the beginning of a DRX Cycle;
MBS DRX Inactivity timer (may be represented as drx-InactivityTimerMBS), which indicates the duration after the PDCCH occasion in which a PDCCH indicates a new DL transmission for the G-RNTI;
MBS DRX retransmission timer (may be represented as drx-RetransmissionTimerMBS), which indicates the maximum duration until a DL retransmission is received; and
MBS DRX HARQ RTT timer (may be represented as drx-HARQ-RTT-TimerDLMBS), which indicates the minimum duration before a DL assignment for HARQ retransmission is expected by the MAC entity.

The active time period is an MBS DRX active time period, the MBS DRX active time period indicates an active time period while one of drx-onDurationTimerMBS, drx-InactivityTimerMBS and drx-RetransmissionTimerMBS is running. In particular, the MBS DRX inactive time period may be divided into two parts:
a first active period (active time 1): a period while one of drx-onDurationTimerMBS, drx-InactivityTimerMBS is running. During active time 1, the UE monitors group common PDCCH for the G-RNTI; and
a second active period (active time 2): a period while drx-RetransmissionTimerMBS is running. During active time 2, the UE monitors UE specific PDCCH for the UE's C-RNTI in the case that only the PTM retransmission over PTP is supported, or the UE monitors group common PDCCH for the G-RNTI in the case that only the PTM retransmission over PTM is supported, or the UE monitors PDCCH with CRC scrambled by C-RNTI and PDCCH with CRC scrambled by G-RNTI in the case that both the PTM retransmission over PTP and the PTM retransmission over PTM are supported.

The BS may transmit PDCCH for the G-RNTI while one of an MBS DRX on duration timer and an MBS DRX inactivity timer is running, and at least one of PDCCH for the C-RNTI of the UE and PDCCH for the G-RNTI while an MBS DRX retransmission timer is running.

For example, the detailed procedure may include: When DRX is configured for a G-RNTI or for an MBS Session, the MAC entity shall:
1> if the DRX group is in Active Time 1:
   2> monitor the group common PDCCH for the G-RNTI;
   2> if the group common PDCCH indicates a DL transmission and HARQ is enabled/configured for the G-RNTI:
      3> start the drx-HARQ-RTT-TimerMBS for the corresponding HARQ process in the first symbol after the end of the corresponding transmission carrying the DL HARQ feedback;
      3> stop the drx-RetransmissionTimerMBS for the corresponding HARQ process.
      3> if HARQ-ACK feedback for the group-common HARQ is disabled:
         4> start the drx-RetransmissionTimerMBS in the first symbol after the PDSCH transmission for the corresponding HARQ process.
   2> if the group common PDCCH indicates a new transmission for the G-RNTI:
      3> start or restart drx-InactivityTimerMBS for this DRX in the first symbol after the end of the PDCCH reception.
1> if the DRX group is in Active Time 2:
   2> monitor the UE specific PDCCH for the UE's C-RNTI in case only the PTM retransmission over PTP is supported, or the UE monitors group common PDCCH for the G-RNTI in case only the PTM retransmission over PTM is supported, or the UE monitors PDCCH with CRC scrambled by C-RNTI and PDCCH with CRC scrambled by G-RNTI in case both the PTM retransmission over PTP and the PTM retransmission over PTM are supported.

In the embodiment, the UE would distinguish that the retransmission comes from PTM or PTP so that the UE can decide to monitor C-RNTI or G-RNTI during the active time 2.

In an example, the BS may indicate in the DCI, whether the corresponding retransmission will be scrambled using G-RNTI (that is the PTM retransmission over PTM) or C-RNTI (that is the PTM retransmission over PTP). After receiving the indication, the UE is able to know whether to monitor G-RNTI or C-RNTI.

In another example, the UE may determine to monitor G-RNTI or C-RNTI according to if MBS DRX related retransmission timers (such as, drx-RetranmssionTimerMBS, drx-HARQ-RTT-TimerDLMBS) are configured. If drx-RetranmssionTimerMBS, drx-HARQ-RTT-TimerDLMBS are configured, the UE may monitor G-RNTI for retransmission, else the UE may monitor C-RNTI for retransmission.

In the case of PTM and PTP switching, the PTM transmission (can include PTM initial transmission and PTM retransmission) may be disabled or deactivated. If the PTM transmission is disabled or deactivated, the UE may disable or suspend the MBS specific DRX operation. For example, when the UE receives PTM disable or deactivation command from network, the UE may stop all related timers (e.g. drx-onDurationTimerMBS) and may not monitor the group common PDCCH with CRC scrambled by G-RNTI.

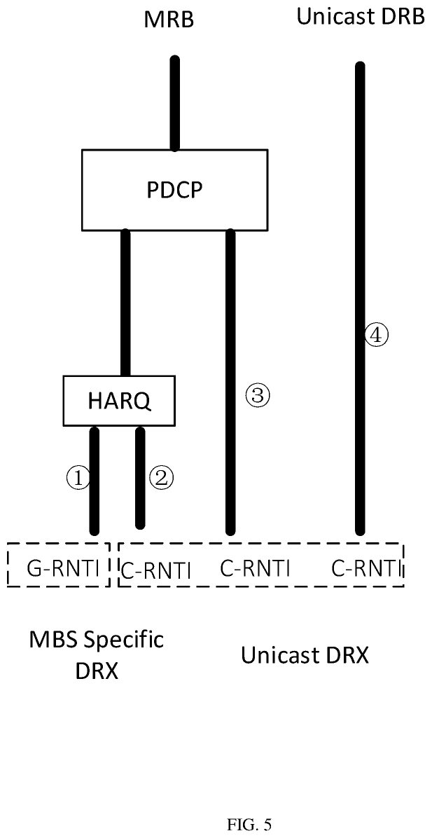

FIG. 5 is a diagram illustrating a method for configuring DRX operation for MBS according to another embodiment of the present application.

As shown in FIG. 5, \textcircled{1} may represent a PTM transmission including a PTM initial transmission and/or a PTM retransmission over PTM, \textcircled{2} may represent a PTM retransmission over PTP, \textcircled{3} may represent a PTP transmission, and \textcircled{4} may represent a unicast transmission.

In this embodiment, the MBS specific DRX operation is only configured for PTM transmission (\textcircled{1}), while a unicast DRX operation is used for PTM retransmission over PTP(\textcircled{2}), PTP transmission (\textcircled{3}), and a unicast transmission (\textcircled{4}).

In this embodiment, the MBS specific DRX operation may be per G-RNTI or per MBS session. In particular, if MBS specific DRX operation is configured for a G-RNTI, the UE is allowed to monitor the PDCCH for this G-RNTI discontinuously using the DRX operation specified. RRC controls its DRX operation by configuring the timers:
MBS DRX on duration timer (may be represented as drx-onDurationTimerMBS), which indicates the duration at the beginning of a DRX Cycle;
MBS DRX Inactivity timer (may be represented as drx-InactivityTimerMBS), which indicates the duration after the PDCCH occasion in which a PDCCH indicates a new DL transmission for the G-RNTI;
MBS DRX retransmission timer (may be represented as drx-RetransmissionTimerMBS), which indicates the maximum duration until a DL retransmission is received; and
MBS DRX HARQ RTT timer (may be represented as drx-HARQ-RTT-TimerDLMBS), which indicates the minimum duration before a DL assignment for HARQ retransmission is expected by the MAC entity.

In this embodiment, the drx-RetransmissionTimerMBS and drx-HARQ-RTT-TimerDLMBS may not be configured and the legacy drx-HARQ-RTT-TimerDL and the drx-RetransmissionTimerDL can be reused as a retransmission timer (drx-RetransmissionTimerMBS) and a HARQ RTT timer (drx-HARQ-RTT-TimerDLMBS) for the MBS DRX operation.

The active time period may include an active time period for the MBS DRX operation and an active time period for the unicast DRX operation.

The active time period for the MBS DRX operation indicates an active time period while one of an MBS DRX on duration timer and an MBS DRX inactivity timer is running. During the active time period for the MBS DRX operation, the UE monitors the group common PDCCH for the G-RNTI.

The active time period for the unicast DRX operation indicates an active time period while an MBS DRX retransmission timer is running. During the active time period for the unicast DRX operation, the UE starts the unicast DRX operation and monitors PDCCH for the UE's C-RNTI.

For example, the detailed procedure may include: When DRX is configured for a G-RNTI or for an MBS Session, the MAC entity shall:
1> if the DRX group is in Active Time:
   2> monitor the group common PDCCH for the G-RNTI;
   2> if the group common PDCCH indicates a DL transmission and HARQ is enabled/configured for the G-RNTI:
      3> start the drx-HARQ-RTT-TimerMBS for the corresponding HARQ process;
      3> stop the drx-RetransmissionTimerMBS for the corresponding HARQ process.
      3> if the PDSCH-to-HARQ_feedback timing indicate a non-numerical kl value:
         4> start the drx-RetransmissionTimerMBS in the first symbol after the PDSCH transmission for the corresponding HARQ process.
         4> start the unicast DRX operation with considering the drx-RetransmissionTimerMBS as active time for the unicast DRX operation.

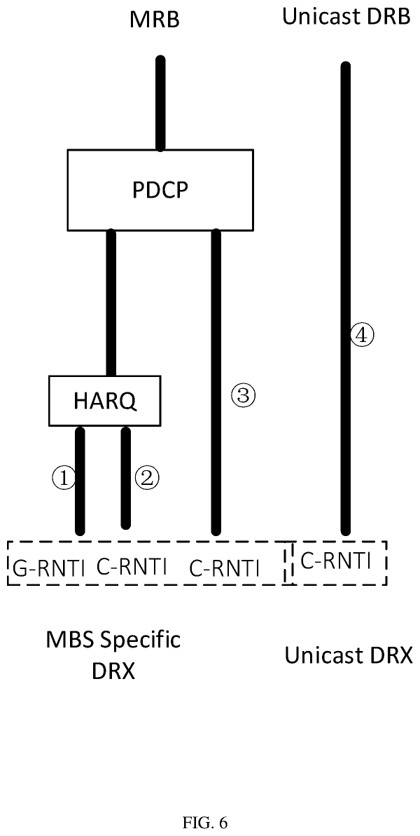

FIG. 6 is a diagram illustrating a method for configuring DRX operation for MBS according to another embodiment of the present application.

As shown in FIG. 6, \textcircled{1} may represent a PTM transmission including PTM initial transmission and/or PTM retransmission over PTM, \textcircled{2} may represent a PTM retransmission over PTP, \textcircled{3} may represent a PTP transmission, and \textcircled{4} may represent a unicast transmission.

In this embodiment, the MBS specific DRX operation is configured for PTM transmission (\textcircled{1}), PTM retransmission over PTP(\textcircled{2}), and PTP transmission (\textcircled{3}), while a unicast DRX operation is used for a unicast transmission (\textcircled{4}).

In this embodiment, the MBS specific DRX operation may be per G-RNTI. And the HARQ retransmission related timers (for example, MBS DRX retransmission timer and MBS DRX HARQ RTT timer) are also MBS specific. For example, the HARQ retransmission related timers can be per MBS specific DRX operation (that is, per G-RNTI).

In particular, if MBS specific DRX operation is configured for a G-RNTI, the UE is allowed to monitor the group common PDCCH for this G-RNTI discontinuously using the DRX operation specified. RRC controls its DRX operation by configuring the timers: drx-onDurationTimerMBS, drx-InactivityTimerMBS, drx-RetransmissionTimerMBS, and drx-HARQ-RTT-TimerDLMBS. The meanings of the timers here are the same as those described above, which will not be described in detail.

The active time period indicates an active time period while one of one of drx-onDurationTimerMBS, drx-InactivityTimerMBS and drx-RetransmissionTimerMBS is running. During the active time period, the UE monitors group common PDCCH for the G-RNTI and UE specific PDCCH for the UE's C-RNTI.

The BS may transmit PDCCH for the G-RNTI and PDCCH for the C-RNTI of the UE while one of an MBS DRX on duration timer, an MBS DRX inactivity timer and an MBS DRX retransmission timer is running.

For example, the detailed procedure may include: When DRX is configured for a G-RNTI or for an MBS Session, the MAC entity shall:
1> if the DRX group is in Active Time:
   2> monitor both the group common PDCCH for the G-RNTI and UE specific PDCCH with C-RNTI;
   2> if the PDCCH indicates a DL transmission and HARQ is enabled/configured for the G-RNTI:
      3> start the drx-HARQ-RTT-TimerMBS for the corresponding HARQ process;
      3> stop the drx-RetransmissionTimerMBS for the corresponding HARQ process.
      3> if the PDSCH-to-HARQ_feedback timing indicate a non-numerical kl value:
         4> start the drx-RetransmissionTimerMBS in the first symbol after the PDSCH transmission for the corresponding HARQ process.
   2> if the PDCCH indicates a new transmission for the G-RNTI:
      3> start or restart drx-InactivityTimerMBS for this DRX in the first symbol after the end of the PDCCH reception.

Currently, both PTP transmission and unicast transmission are scrambled by the same C-RNTI, so that the UE cannot distinguish PTP transmission and unicast transmission in physical layer.

In this embodiment, since different DRX operations are used for the PTP transmission and unicast transmission, the UE would distinguish PTP transmission and unicast transmission.

In an example, the BS may allocate a different C-RNTI for PTP transmission from a C-RNTI for unicast transmission. If the PDCCH is scrambled by the C-RNTI for PTP transmission per MBS session, the UE operates the MBS specific DRX operation. If the PDCCH is scrambled by the C-RNTI for unicast transmission, the UE operates the unicast DRX operation.

In another example, the BS may allocate dedicated HARQ process ID(s) for MBS session. The UE may identify the PTP transmission using the HARQ process ID. If the HARQ process ID is for MBS, the UE operates MBS specific DRX operation.

In yet another example, the BS may indicate in the DCI, whether the transmission is the PTP transmission or the unicast transmission. After receiving the indication, the UE knows it should operate the MBS specific DRX operation or the unicast operation.

In the above embodiments, the MBS DRX operation and the unicast DRX operation are different. In another embodiment, a common DRX operation may be configured for MBS and unicast transmission, and separate retransmission related timers may be configured for MBS and unicast transmission.

In this embodiment, common DRX operation is used for MBS and unicast bearers. However, separate retransmission related timers are configured for MBS. For example, drx-HARQ-RTT-TimerMBS and drx-HARQ-RTT-TimerMBS are configured for PTM retransmission for MBS. Both drx-RetransmissionTimerMBS and drx-RetransmissionTimerDL are active time for the DRX operation.

For example, the detailed procedure may include: When DRX is configured for a G-RNTI or for an MBS Session, the MAC entity shall:
1> if the DRX group is in Active Time:
   2> monitor PDCCH (including both the group common PDCCH for the G-RNTI and UE specific PDCCH with C-RNTI)
   2> if the group common PDCCH indicates a DL transmission and HARQ is enabled/configured for the G-RNTI:
      3> start the drx-HARQ-RTT-TimerMBS for the corresponding HARQ process;
      3> stop the drx-RetransmissionTimerMBS for the corresponding HARQ process.
      3> if the PDSCH-to-HARQ_feedback timing indicate a non-numerical kl value:
         4> start the drx-RetransmissionTimerMBS in the first symbol after the PDSCH transmission for the corresponding HARQ process.
   2> if the UE specific PDCCH indicates a DL transmission:
      3> start the drx-HARQ-RTT-TimerDL for the corresponding HARQ process;
      3> stop the drx-RetransmissionTimerDL for the corresponding HARQ process.
      3> if the PDSCH-to-HARQ_feedback timing indicate a non-numerical kl value:
         4> start the drx-RetransmissionTimerDL in the first symbol after the PDSCH transmission for the corresponding HARQ process.

In yet another embodiment, separate active time and common configuration for other timers is configured for MBS and unicast transmission.

In this embodiment, MBS specific on duration timer and/or MBS specific inactivity timer are configured per MBS session (G-RNTI). The other timers, for example, the MBS specific DRX operation and unicast DRX operation may share the following parameter values: a DRX slot offset (drx-SlotOffset), a DRX retransmission timer (drx-RetransmissionTimerDL), a DRX a long cycle start offset (drx-LongCycleStartOffset), a DRX short cycle (drx-ShortCycle) (optional), a DRX short cycle timer (drx-ShortCycleTimer) (optional), a DRX HARQ RTT timer (drx-HARQ-RTT-TimerDL).

In another embodiment, the DRX start offset and DRX slot offset may also be MBS specific or per MBS session.

Embodiments of the present application can realize efficient power saving for NR MBS for a UE in high reliability multicast service supporting HARQ and retransmission.

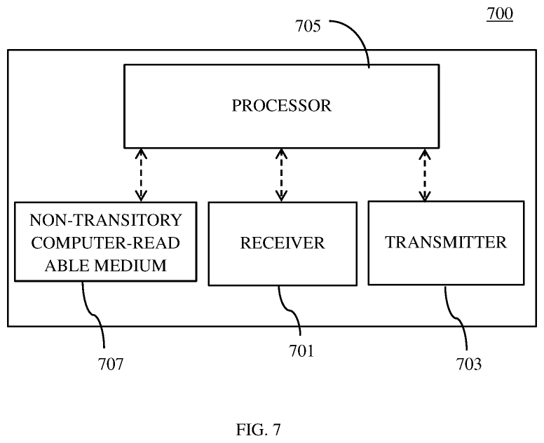

FIG. 7 illustrates an apparatus according to some embodiments of the present application. In some embodiments of the present application, the apparatus 700 may be the UE 102 (UE 102a or UE 102b) as illustrated in FIG. 1 or the UE in other embodiments of the present application.

As shown in FIG. 7, the apparatus 700 may include a receiver 701, a transmitter 703, a processer 705, and a non-transitory computer-readable medium 707. The non-transitory computer-readable medium 707 has computer executable instructions stored therein. The processer 705 is configured to be coupled to the non-transitory computer readable medium 707, the receiver 701, and the transmitter 703. It can be contemplated that the apparatus 700 may include more computer-readable mediums, receiver, transmitters and processors in some other embodiments of the present application according to practical requirements. In some embodiments of the present application, the receiver 701 and the transmitter 703 can be integrated into a single device, such as a wireless transceiver. In certain embodiments, the apparatus 700 may further include an input device, a memory, and/or other components.

In some embodiments of the present application, the non-transitory computer-readable medium 707 may have stored thereon computer-executable instructions to cause processer 705 to implement the method performed by the UE according to embodiments of the present application. For example, the processer 705 may be configured to perform, during an active time period, monitor a PTM initial transmission with a first identifier; and monitor a PTM retransmission with the first identifier, or a second identifier, or both of the first and second identifiers. It should be understood that the processer 705 may be further configured to perform other operations or actions in the above description, which will not be described in detail for avoiding repetition.

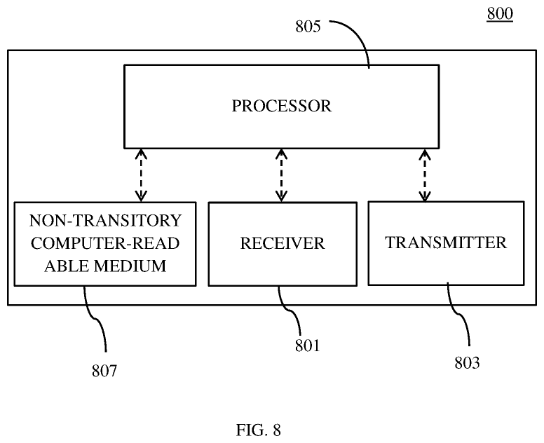

FIG. 8 illustrates another apparatus according to some embodiments of the present application. In some embodiments of the present application, the apparatus 800 may be the BS 101 as illustrated in FIG. 1 or the BS in other embodiments of the present application.

As shown in FIG. 8, the apparatus 800 may include a receiver 801, a transmitter 803, a processer 805, and a non-transitory computer-readable medium 807. The non-transitory computer-readable medium 807 has computer executable instructions stored therein. The processer 805 is configured to be coupled to the non-transitory computer readable medium 807, the receiver 801, and the transmitter 803. It is contemplated that the apparatus 800 may include more computer-readable mediums, receiver, transmitters and processors in some other embodiments of the present application according to practical requirements. In some embodiments of the present application, the receiver 801 and the transmitter 803 can be integrated into a single device, such as a wireless transceiver. In certain embodiments, the apparatus 800 may further include an input device, a memory, and/or other components.

In some embodiments of the present application, the non-transitory computer-readable medium 807 may have stored thereon computer-executable instructions to cause the apparatus 800 to implement the method performed by the BS according to embodiments of the present application.

Some embodiments of the present disclosure may be disclosed below:
Embodiment 1: A method performed by a user equipment (UE), which is configured with a multicast and broadcast services (MBS) discontinuous reception (DRX) operation, the method comprising: during an active time period for the MBS DRX operation,
   monitoring a point to multipoint (PTM) initial transmission associated with a MBS from a base station, wherein the PTM initial transmission is further associated with a first identifier; and
   monitoring a PTM retransmission associated with the MBS from a base station, wherein the PTM retransmission is further associated with the first identifier, or a second identifier, or both of the first and second identifiers.
Embodiment 2: The method of Embodiment 1, wherein the first identifier is a group radio network temporary identifier (G-RNTI), and the second identifier is a cell radio network temporary identifier (C-RNTI) of the UE.
Embodiment 3: The method of Embodiment 1, wherein the MBS DRX operation is configured for the PTM initial transmission and the PTM retransmission,
   the active time period is an MBS DRX active time period, the MBS DRX active time period includes a first MBS DRX active time period and a second MBS DRX active time period, and the first MBS DRX active time period indicates an active time period while one of an MBS DRX on duration timer and an MBS DRX inactivity timer is running, and the second MBS DRX active time period indicates an active time period while an MBS DRX retransmission timer is running.
Embodiment 4: The method of Embodiment 3, wherein
   during the first MBS DRX active time period, the UE monitors physical downlink control channel (PDCCH) for the first identifier, and
   during the second MBS DRX active time period, the UE monitors PDCCH for the second identifier in the case of PTM retransmission over PTP, the UE monitors PDCCH for the first identifier in the case of PTM retransmission over PTM, or the UE monitors both PDCCH for the second identifier and PDCCH for the first identifier in the case that both PTM retransmission over PTP and the PTM retransmission over PTM are supported.
Embodiment 5: The method of Embodiment 4, wherein the UE decides to monitor PDCCH for the second identifier or monitor PDCCH for the first identifier based on at least one of the following:
   an indication in downlink control information (DCI) indicating whether the PTM retransmission is over PTP or over PTM; or
   if MBS DRX related retransmission timers are configured.
Embodiment 6: The method of Embodiment 3, wherein in the case of PTM and PTP switching, the PTM transmission are disabled or deactivated and the UE disables or suspends the MBS DRX operation.
Embodiment 7: The method of Embodiment 1, wherein the MBS DRX operation is configured for the PTM initial transmission, and a unicast DRX operation is configured for the PTM retransmission over PTP,
   the active time period includes an active time period for the MBS DRX operation and an active time period for the unicast DRX operation, the active time period for the MBS DRX operation indicates an active time period while one of an MBS DRX on duration timer and an MBS DRX inactivity timer is running, and the active time period for the unicast DRX operation indicates an active time period while an MBS DRX retransmission timer is running.
Embodiment 8: The method of Embodiment 7, wherein
   during the active time period for the MBS DRX operation, the UE monitors PDCCH for the first identifier, and
   during the active time period for the unicast DRX operation, the UE starts the unicast DRX operation and monitors PDCCH for the second identifier.
Embodiment 9: The method of Embodiment 7, wherein a hybrid automatic repeat request (HARQ) round-trip time (RTT) timer and a retransmission timer for unicast DRX operation are reused as a retransmission timer and a HARQ RTT timer for the MBS DRX operation.
Embodiment 10: The method of Embodiment 1, wherein the MBS DRX operation is configured for the PTM initial transmission, the PTM retransmission, and a PTP transmission,
   the active time period indicates an active time period while one of an MBS DRX on duration timer, an MBS DRX inactivity timer and an MBS DRX retransmission timer is running.
Embodiment 11: The method of Embodiment 10, wherein
   during the active time period, the UE monitors PDCCH for the first identifier and PDCCH for the second identifier.
Embodiment 12: The method of Embodiment 11, wherein a unicast DRX operation is configured for a unicast transmission, and the UE distinguishes the PTP transmission and the unicast transmission based on at least one of the following:
   whether PDCCH is scrambled by a first C-RNTI for the PTP transmission or scrambled by a second C-RNTI for the unicast transmission different from the first C-RNTI for the PTP transmission;
   a HARQ process ID dedicated for MBS session indicating the PTP transmission; and
   an indication in DCI indicating whether the transmission is the PTP transmission or the unicast transmission.
Embodiment 13: The method of Embodiment 1, wherein the MBS DRX operation and a unicast DRX operation are a same DRX operation.
Embodiment 14: The method of Embodiment 13, wherein an MBS DRX HARQ RTT timer and an MBS DRX retransmission timer are configured for the PTM retransmission.
Embodiment 15: The method of Embodiment 13, wherein during the active time period, the UE monitors PDCCH for the first identifier and PDCCH for the second identifier.
Embodiment 16: The method of Embodiment 1, wherein an MBS DRX on duration timer and/or an MBS DRX inactivity timer are configured for MBS.
Embodiment 17: The method of Embodiment 16, wherein the MBS DRX operation and an unicast DRX operation share at least one of the following parameter values: a DRX slot offset, a DRX retransmission timer, a DRX a long cycle start offset, a DRX short cycle, a DRX short cycle timer, and a DRX HARQ RTT timer.
Embodiment 18: The method of Embodiment 16, wherein DRX start offset and DRX slot offset are specific for MBS.
Embodiment 19: A method performed by a base station (BS), comprising:
   configuring a value for at least one timer for a point to multipoint (PTM) initial transmission, PTM retransmission, and a point to point (PTP) transmission of multicast and broadcast services (MBS) discontinuous reception (DRX) operation to a UE.
Embodiment 20: The method of Embodiment 19, wherein the at least one timer comprises one or more of an MBS DRX on duration timer, an MBS DRX inactivity timer, an MBS DRX retransmission timer, and an MBS DRX HARQ RTT timer.
Embodiment 21: The method of Embodiment 20, further comprising:
   transmitting the PTM initial transmission with a first identifier; and
   transmitting the PTM retransmission with the first identifier or a second identifier.
Embodiment 22: The method of Embodiment 21, wherein the first identifier is a group radio network temporary identifier (G-RNTI), and the second identifier is a cell radio network temporary identifier (C-RNTI) of the UE.
Embodiment 23: The method of Embodiment 21, wherein the BS transmits
   PDCCH for the first identifier while one of an MBS DRX on duration timer and an MBS DRX inactivity timer is running, and
   at least one of PDCCH for the second identifier and PDCCH for the first identifier while an MBS DRX retransmission timer is running.
Embodiment 24: The method of Embodiment 21, wherein a DRX HARQ RTT timer and a DRX retransmission timer for unicast DRX operation are reused as a retransmission timer and a HARQ RTT timer for MBS DRX operation.
Embodiment 25: The method of Embodiment 21, wherein the BS transmits PDCCH for the first identifier and PDCCH for the second identifier while one of an MBS DRX on duration timer, an MBS DRX inactivity timer and an MBS DRX retransmission timer is running.
Embodiment 26: The method of Embodiment 20, wherein in the case that MBS DRX operation and a unicast DRX operation are a common DRX operation for the UE, an MBS DRX HARQ RTT timer and an MBS DRX retransmission timer are configured for the PTM retransmission.
Embodiment 27: The method of Embodiment 20, wherein an MBS DRX on duration timer and an MBS DRX inactivity timer are configured for MBS, and at least one of a DRX slot offset, a DRX retransmission timer, a DRX long cycle start offset, a DRX short cycle, a DRX short cycle timer, and a DRX HARQ RTT timer for a unicast DRX operation are shared with the MBS DRX operation.
Embodiment 28: An apparatus, comprising:
   a processor; and
   a wireless transceiver coupled to the processor,
      wherein the processor is configured to:
   perform a method according to any one of Embodiments 1-27 with the wireless transceiver.

Persons skilled in the art should understand that as the technology develops and advances, the terminologies described in the present application may change, and should not affect or limit the principle and spirit of the present application.

Those having ordinary skill in the art would understand that the steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method performed by a user equipment (UE), the method comprising:
during an active time period for a multicast and broadcast services (MBS) discontinuous reception (DRX) operation,
monitoring a point to multipoint (PTM) initial transmission associated with a MBS from a base station, wherein the PTM initial transmission is further associated with a first identifier; and
monitoring a PTM retransmission associated with the MBS from a base station, wherein the PTM retransmission is further associated with the first identifier, a second identifier, or both of the first and second identifiers.

2. The method of claim 1, wherein the first identifier is a group radio network temporary identifier (G-RNTI), and the second identifier is a cell radio network temporary identifier (C-RNTI) of the UE.

3. The method of claim 1, wherein the MBS DRX operation is configured for the PTM initial transmission and the PTM retransmission, the active time period is an MBS DRX active time period, the MBS DRX active time period includes a first MBS DRX active time period and a second MBS DRX active time period, and the first MBS DRX active time period indicates an active time period while one of an MBS DRX on duration timer and an MBS DRX inactivity timer is running, and the second MBS DRX active time period indicates an active time period while an MBS DRX retransmission timer is running.

4. The method of claim 3, further comprising:
during the first MBS DRX active time period, the monitoring a physical downlink control channel (PDCCH) for the first identifier, and
during the second MBS DRX active time period, monitoring the PDCCH for the second identifier for PTM retransmission over PTP, monitoring the PDCCH for the first identifier for PTM retransmission over PTM, or monitoring both of the PDCCH for the second identifier and the PDCCH for the first identifier if both PTM retransmission over PTP and the PTM retransmission over PTM are supported.

5. The method of claim 4, further comprising deciding to monitor the PDCCH for the second identifier or monitor the PDCCH for the first identifier based on:
an indication in downlink control information (DCI) indicating whether the PTM retransmission is over PTP or over PTM;
if MBS DRX related retransmission timers are configured;
or a combination thereof.

6. The method of claim 1, wherein the MBS DRX operation is configured for the PTM initial transmission, and a unicast DRX operation is configured for the PTM retransmission over PTP, the active time period includes an active time period for the MBS DRX operation and an active time period for the unicast DRX operation, the active time period for the MBS DRX operation indicates an active time period while one of an MBS DRX on duration timer and an MBS DRX inactivity timer is running, and the active time period for the unicast DRX operation indicates an active time period while an MBS DRX retransmission timer is running.

7. The method of claim 6, further comprising:
during the active time period for the MBS DRX operation, monitoring a physical downlink control channel (PDCCH) PDCCH for the first identifier, and
during the active time period for the unicast DRX operation, starting the unicast DRX operation and monitors the PDCCH for the second identifier.

8. The method of claim 1, wherein the MBS DRX operation is configured for the PTM initial transmission, the PTM retransmission, and a PTP transmission, the active time period indicates an active time period while one of an MBS DRX on duration timer, an MBS DRX inactivity timer and an MBS DRX retransmission timer is running.

9. The method of claim 8, further comprising:
during the active time period, monitoring a physical downlink control channel (PDCCH) PDCCH for the first identifier and the PDCCH for the second identifier.

10. The method of claim 1, wherein the MBS DRX operation and a unicast DRX operation are a same DRX operation.

11. The method of claim 10, wherein an MBS DRX HARQ RTT timer and an MBS DRX retransmission timer are configured for the PTM retransmission.

12. The method of claim 10, further comprising, during the active time period, monitoring a physical downlink control channel (PDCCH) for the first identifier and the PDCCH for the second identifier.

13. The method of claim 1, wherein an MBS DRX on duration timer and/or an MBS DRX inactivity timer are configured for MBS.

14. The method of claim 13, wherein the MBS DRX operation and a unicast DRX operation share: a DRX slot offset, a DRX retransmission timer, a DRX a long cycle start offset, a DRX short cycle, a DRX short cycle timer, a DRX HARQ RTT timer, or a combination thereof.

15. (canceled)

16. A user equipment (UE), comprising:
at least one memory; and
at least one processor coupled with the at least one memory and configured to cause the UE to:
during an active time period for a multicast and broadcast services (MBS) discontinuous reception (DRX) operation,
monitor a point to multipoint (PTM) initial transmission associated with a MBS from a base station, wherein the PTM initial transmission is further associated with a first identifier; and
monitor a PTM retransmission associated with the MBS from a base station, wherein the PTM retransmission is further associated with the first identifier, a second identifier, or both of the first and second identifiers.

17. The UE of claim 16, wherein the first identifier is a group radio network temporary identifier (G-RNTI), and the second identifier is a cell radio network temporary identifier (C-RNTI) of the UE.

18. The UE of claim 16, wherein the MBS DRX operation is configured for the PTM initial transmission and the PTM retransmission, the active time period is an MBS DRX active time period, the MBS DRX active time period includes a first MBS DRX active time period and a second MBS DRX active time period, and the first MBS DRX active time period indicates an active time period while one of an MBS DRX on duration timer and an MBS DRX inactivity timer is running, and the second MBS DRX active time period indicates an active time period while an MBS DRX retransmission timer is running.

19. The UE of claim 18, wherein the at least one processor is configured to cause the UE to:
during the first MBS DRX active time period, monitor a physical downlink control channel (PDCCH) for the first identifier, and
during the second MBS DRX active time period, monitor the PDCCH for the second identifier for PTM retransmission over PTP, monitor the PDCCH for the first identifier for PTM retransmission over PTM, or monitor both of the PDCCH for the second identifier and the PDCCH for the first identifier if both PTM retransmission over PTP and the PTM retransmission over PTM are supported.

20. The UE of claim 19, wherein the at least one processor is configured to cause the UE to decide to monitor the PDCCH for the second identifier or monitor the PDCCH for the first identifier based on:
an indication in downlink control information (DCI) indicating whether the PTM retransmission is over PTP or over PTM;
if MBS DRX related retransmission timers are configured;
or a combination thereof.

21. A processor for wireless communication, comprising:
at least one controller coupled with at least one memory and configured to cause the processor to:
during an active time period for a multicast and broadcast services (MBS) discontinuous reception (DRX) operation,
monitor a point to multipoint (PTM) initial transmission associated with a MBS from a base station, wherein the PTM initial transmission is further associated with a first identifier; and
monitor a PTM retransmission associated with the MBS from a base station, wherein the PTM retransmission is further associated with the first identifier, a second identifier, or both of the first and second identifiers.
